(19) United States
(12) Patent Application Publication
(10) Pub. No.: US 2006/0292915 A1
(43) Pub. Date: Dec. 28, 2006

(54) LATCH FOR A HITCH MOUNTABLE LOAD CARRIER

(75) Inventors: Kevin Bogoslofski, Southington, CT (US); William Fortune, Branford, CT (US); Theodore Niedziela, Southbury, CT (US)

Correspondence Address: NOVAK DRUCE & QUIGG, LLP, 1300 EYE STREET NW, 400 EAST TOWER, WASHINGTON, DC, 20005, US

(73) Assignee: THULE SWEDEN AB, Hillerstorp (SE)

(21) Appl. No.: 11/306,853

(22) Filed: Jan. 12, 2006

Related U.S. Application Data
(60) Provisional application No. 60/689,158, filed on Jun. 10, 2005.

(51) Int. Cl. H01R 13/627

(52) U.S. Cl. 439/352

(57) ABSTRACT

A vehicular load carrier including a hinge having an open position and a closed position. The load carrier includes a first beam having a first end attached to the hinge, and a second end deploying a projection. A second beam is attached to the hinge for rotation relative to the first beam. The second beam has an edge for mounting a rotatable rod having a handle opposite a curved latch. Upon rotation of the handle, between a first position and a second position, the curved latch moves from a released position to a position where it engages the projection to hold the first beam and the second beam together when the hinge is in its closed position.

### CROSS-REFERENCE TO RELATED APPLICATIONS

The present application claims the benefit of U.S. Provisional Application No. 60/689,158 filed Jun. 10, 2005. Said application is expressly incorporated herein by reference in its entirety.

### FIELD OF THE INVENTION

The present invention relates generally to articles including modular-type carrier assemblies mounted upon a transporting vehicle. An exemplary embodiment utilized herein for illustrative purposes is a hitch-mounted vehicular load carrier designed for supporting a variety of articles including storage containers. A disclosed assembly includes a hinged, swing-away frame that provides convenient access for loading and unloading one or more articles, which may be transported by the load carrier.

### BACKGROUND OF THE INVENTION

Attachment of load carriers at rearward positions of vehicles, using hitch-mount receivers, is known. Rear-mounted load carriers typically provide transportation for sports equipment particularly bicycles and the like. Exemplary hitch mount carriers of the hinged or swing-away type include diamond-style extendible carriers and two-arm swing-away carriers. U.S. Pat. No. 6,745,926 (Chimenti) provides reference to a variety of hitch mountable load carriers such as a diamond-style configuration found in U.S. Pat. No. 6,085,954 (Bloemer). Patents including U.S. Pat. No. 6,237,823 (Stewart et al.), U.S. Pat. No. 5,680,976 (Koliopoulos et al.), U.S. Pat. No. 5,664,717 (Joder) U.S. Pat. No. 5,454,496 (Sumida et al.) and U.S. Pat. No. 5,439,151 (Clayton) disclose carriers of the two-arm swing-away type.

Swing-away type load carriers allow separation of articles and various forms of equipment from a transporting vehicle during loading and unloading. A basic form of swing-away load carrier includes a support arm mountable to a vehicle and having a pivoting connection to an extending arm. The extending arm rotates about the pivot from an open position to a closed position for abutment with the support arm during vehicular movement. An extending arm tends to sag at the pivot point depending on the amount of play in that component. An extending arm of a load carrier will show increased tendency to sag as weight on the extending arm increases, whether or not the extending arm is in the open or closed position.

Increased sagging of an extending arm of a load carrier produces an angular displacement with respect to the support arm mounted to the vehicle. Preferably, there is a parallel relationship between the support arm and the extending arm, particularly when the load carrier is in the closed, traveling configuration. Lack of parallelism between support arm and extending arm causes difficulty when attempting to secure connection between the two. Therefore, it becomes important to compensate for any wobble or play associated with the pivot mechanism that leads to misalignment of a support arm and extending arm of a swing-away type load carrier.

In view of the above described problems with known swing-away type hitch mount carriers, the present invention alleviates drawbacks associated with misalignment of carrier arms to provide further benefits to the user. The benefits are described in greater detail hereinbelow with respect to selected embodiments of the present invention.

### SUMMARY OF THE INVENTION

The present invention incorporates several features that minimize and/or alleviate the disadvantages outlined above. In particular, problems of misalignment between the support arm and extending arm of a swing-away vehicular load carrier may be reduced or eliminated according to the present invention using a rotary latch movable between an engaged position and a released position. Operation of the rotary latch requires a rotating rod that extends away from the rotary latch for remote operation to provide added safety and prevent injury by inadvertent insertion of an operator's fingers or hands in the gripping portion of the latching mechanism.

The rotary latch is part of a vehicular load carrier comprising a pivoting hinge having an open position and a closed position. In its open position the hinge allows convenient access for a user to articles supported on the load carrier. The load carrier further includes a first beam having a first end attached to the hinge, and a second end deploying a projection. A second beam represents an extending arm attached to the hinge for rotation relative to the first beam or support arm. The second beam has an edge for mounting a rotatable rod having a handle opposite a curved latch. Upon rotation of the handle, between a first position and a second position, the curved latch moves from a released position to a position where it engages the projection to secure the first beam against the second beam when the hinge is in its closed position.

The second beam provides an extending arm having a capacity to support weights of about 150 pounds, and preferably less than 200 pounds. Weights of such magnitude place a significant strain on the hinge of the load carrier. As a result, there will be downward displacement of the extending arm resulting in horizontal misalignment between the longitudinal axes of the first beam, corresponding to a support arm, and the second beam. Misalignment will be greatest at distances further away from the hinge.

A latch according to the present invention engages the projection on the first beam to realign the beams upon closure of the hinge that joins the beams together. Re-alignment occurs gradually as a contact surface of the latch first engages the projection then applies a binding force that increases as the latch rotates over the projection to draw the second beam or extending arm closer to the first beam. Increased binding between the projection and the latch occurs because the curved latch has a cam-shaped surface that grips the projection and gradually changes the position of the extending arm for parallel alignment with the first beam or support arm as the latch rotates to a fully tightened position. The curved latch has a dual function for exerting a tight gripping action on the projection to secure the first beam to the second beam and to align the longitudinal axes of the beams in preparation for transporting articles, such as storage containers, on vehicular hitch-mounted load carriers according to the present invention.

A method for securing an extending arm of a vehicular load carrier involves providing such a vehicular load carrier for inserted reception in the hitch of a carrying vehicle. The vehicular load carrier comprises (includes, but is not necessarily limited to) a hinge having an open position and a closed position. A first beam is attached to the hinge by a first end. The first beam has a second end including a projection. A second beam provides the extending arm that is attached to the hinge for rotation relative to the first beam. The second beam includes an edge. A rod mounted to rotate at the edge has a handle opposite a curved latch. Rotation of the handle between a first position and a second position moves the curved latch from a released position to an engaged position with the projection when the hinge is in the closed position. After placing the hinge in the closed position, rotating the handle from the first position to the second position places the curved latch in the engaged position to secure the extending arm against the first beam in a locked position.

At the end of a journey, to move the carrier structure away from the rear of the vehicle or for more convenient access to articles attached to the load carrier, a sequence of steps converts the vehicle mountable load carrier from the locked position to the extended position of the extending arm, wherein the hinge of the load carrier is in its open position. One example of a load carrier according to the present invention may be opened by unlocking the handle attached to the rod opposite the curved latch that secures the extending arm, also referred to herein as the second beam. Once freed, turning the handle causes the rod to rotate, whereby the curved latch retracts from around the projection of to the first beam. The length of the rod provides suitable separation of the handle from the curved latch to prevent operator injury when the latch releases the projection, allowing the extending arm to rotate about the hinge and away from the first beam. Rotation of the extending arm away from the first beam provides space between the rear of the vehicle and articles attached to the extending arm. Maximum vehicle clearance and access to articles occurs when the extending arm has been rotated to its extended position.

More particularly, the present invention provides a vehicular load carrier comprising a hinge having an open position and a closed position. A first beam is attached to the hinge by a first end. The first beam has a second end including a projection. A second beam is attached to the hinge for rotation relative to the first beam. The second beam includes an edge. A rod mounted to rotate at the edge has a handle opposite a curved latch. Rotation of the handle between a first position and a second position moves the curved latch from a released position to an engaged position with the projection when the hinge is in the closed position.

In at least one embodiment of the present invention, a vehicle mountable load carrier comprises a stinger for insertion in a hitch mount receiver of the vehicle. The load carrier includes a hinge having an open position and a closed position. A first beam is attached to the hinge by a first end. The first beam has a second end including a projection. A connector joins the stinger to the second end of the first beam. A second beam is attached to the hinge for rotation relative to the first beam. The second beam includes an edge. A rod mounted to rotate at the edge has a handle opposite a curved latch. Rotation of the handle between a first position and a second position moves the curved latch from a released position to an engaged position with the projection when the hinge is in the closed position.

The beneficial effects described above apply generally to the exemplary devices and mechanisms disclosed herein for a swing-away load carrier including rotating elements lockable for safer loading and unloading of supported articles. The specific structures through which these benefits are delivered will be described in detail herein-below.

### BRIEF DESCRIPTION OF THE DRAWINGS

The invention will now be described in greater detail in the following way of example only and with reference to the accompanying drawings, and in which:

FIG. 1 is a perspective view, illustrating a load carrier configured according to the present invention and positioned at the rear of a transporting vehicle;

FIG. 2 is a perspective view of the load carrier and including a storage container supported on the load carrier;

FIG. 3 is a perspective view of the load carrier in a fully open configuration with an extended arm which shows a carrying frame and reveals a latching mechanism configured according to the present invention;

FIG. 4 is a perspective view of the load carrier with a partially open configuration with an extended arm and showing the latching mechanism in a released configuration relative to a support arm that attaches to the hitch of a vehicle;

FIG. 5 is a perspective view of the load carrier with the extended arm in abutment with a support arm and showing the latching mechanism in an engaged position or configuration;

FIG. 6 is a perspective rear view of the load carrier from a lower direction in which the extending arm is partially open;

FIG. 7 is a perspective view showing the load carrier in which the extending arm is closed against a support arm with a curved latch configured according to the present invention in an engaged position and configuration with a projection on the support beam;

FIG. 8 is a detail perspective view showing means for locking the handle portion of a rotatable rod which acts as an actuator in the present invention;

FIG. 9a through FIG. 9f are perspective views showing the progressive engagement of a curved latch according to the present invention with a projection of a support arm for securing an extending arm to the support arm as well as placing the arms in axial alignment.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

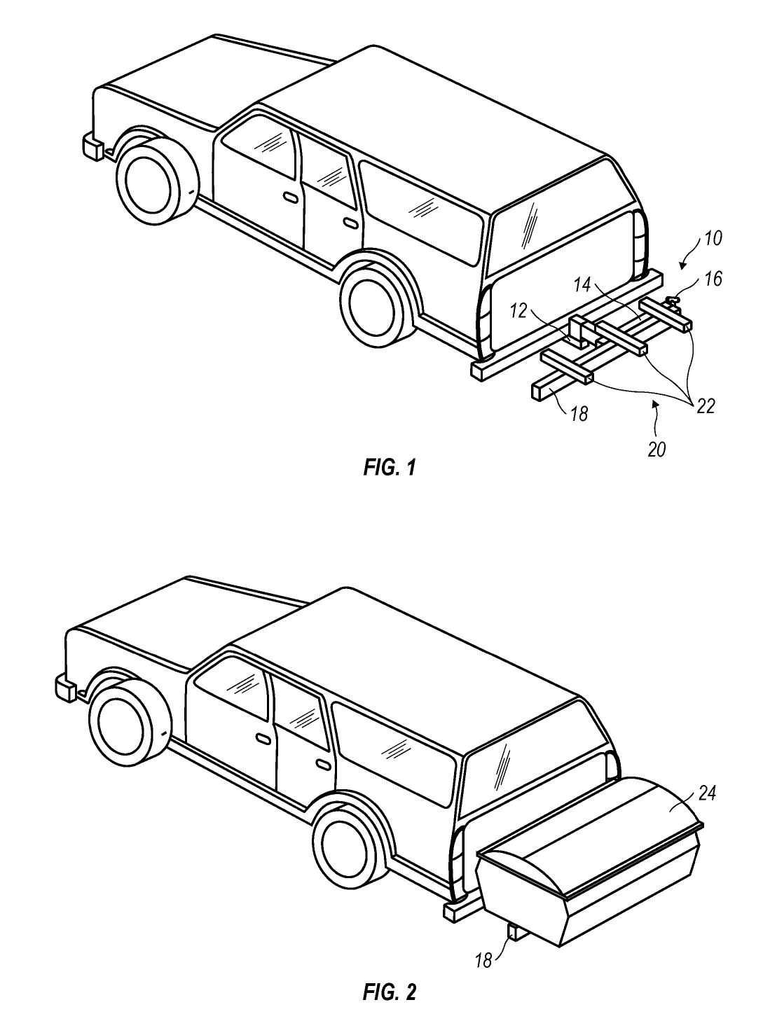

Referring now to the figures wherein like reference numerals identify like parts throughout the several views, FIG. 1 shows a load carrier 10 according to the present invention used for supporting articles, such as storage containers, at the rear of a transporting vehicle. The load carrier 10 includes a stinger 12, inserted in the receiving hitch of the transporting vehicle and connected to a support arm 14 that is joined by a pivoting coupling 16 to a swing-away, extending arm 18 designed for movement from a locked position, during movement of the vehicle, to an extended position. In the extended position of the extendable support arm 18, articles supported on a carrying frame 20 become more accessible for safer loading and unloading. Attachment of an article to a load carrier 10 according to the present invention uses a carrying frame 20, which, as illustrated, has three support bars 22 attached to the extending arm 18. Support bars 22 include means for securing a variety of articles to a carrying frame 20.

FIG. 2 provides illustration of an article, in this case a storage container 24 attached to a carrying frame (not shown) and supported on the extending arm 18 of a load carrier 10 according to the present invention.

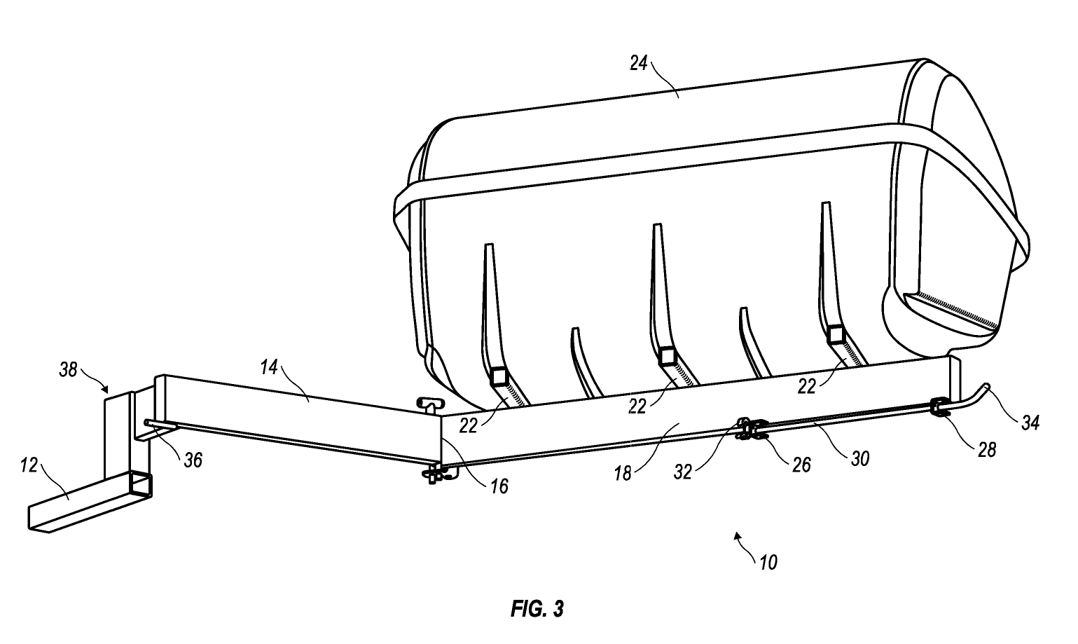

FIG. 3 is a perspective view showing the extending arm 18 swung away from the support arm 14 to reveal the position of the pivoting coupling or hinge 16 and a latching mechanism attached to the extending arm 18 using a first mount 26 and a second mount 28 for suspension of a rotatable rod 30 that has a rotary or curved latch 32 at one end and a handle 34 at the other. The handle 34 rotates between a first position and a second position causing the rod 30 and the curved latch 32 to rotate about the longitudinal axis of the rod 30. When placed in the extended position, the extending arm 18 deploys the carried article 24 farthest away from the body of the vehicle thereby facilitating access to the article, such as the illustrated storage container 24, carried on the frame 20 of the extending arm 18 of the load carrier 10.

The support arm 14 has a projection 36, also referred to herein as a latch pin, at the end of the support arm 14 opposite the hinge 16. The rotary latch 32 engages and rotates about the latch pin or projection 36 to secure the extending arm 18 to the support arm 14 and to place the extending arm 18 in safety and/or locked positions when the hinge 16 is closed.

FIG. 3 shows placement of the storage container 24 on the bars 22 of the carrying frame 20 to which the container 24 may be attached using any of a number of known fastening means. The embodiment shown in FIG. 3 also includes a connector 38 used to rigidly fix the support arm 14 to the stinger 12 that is received in the hitch of a transporting vehicle.

After loading one or more articles 24 on the carrying frame 20 of a load carrier 10 according to the present invention, it is necessary to close the carrier 10 and place the extending arm 18 in a locked position for movement between initial location and final destination. Secure restraint of a load carrier 10 prevents hazardous situations that could cause damage to carried articles, to the transporting vehicle or nearby vehicles if the load carrier 10 were to swing open inadvertently behind the moving vehicle.

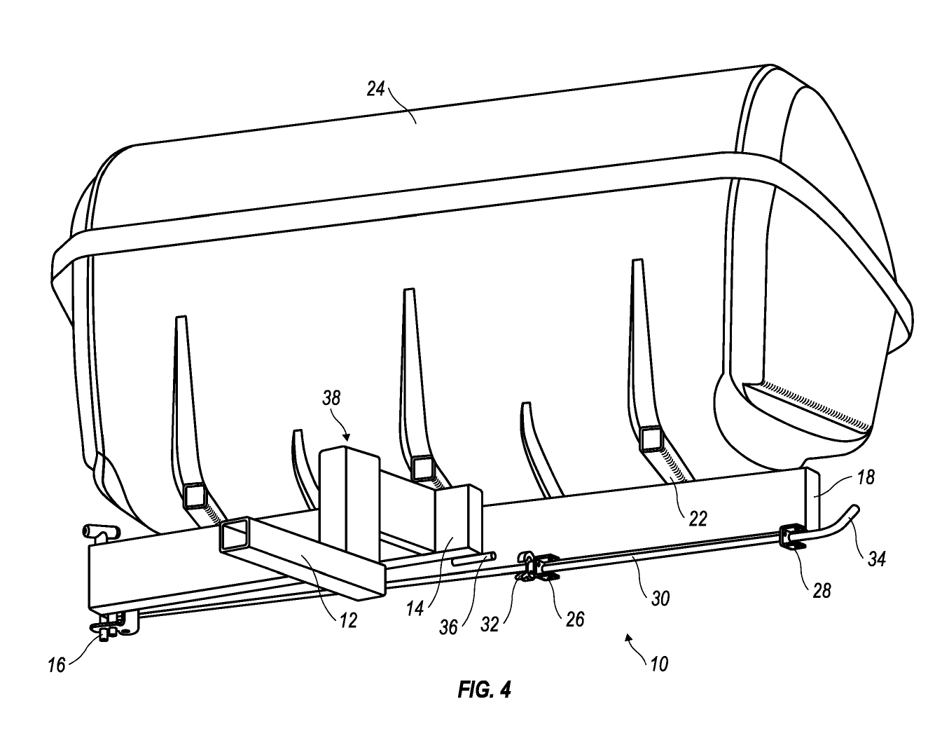

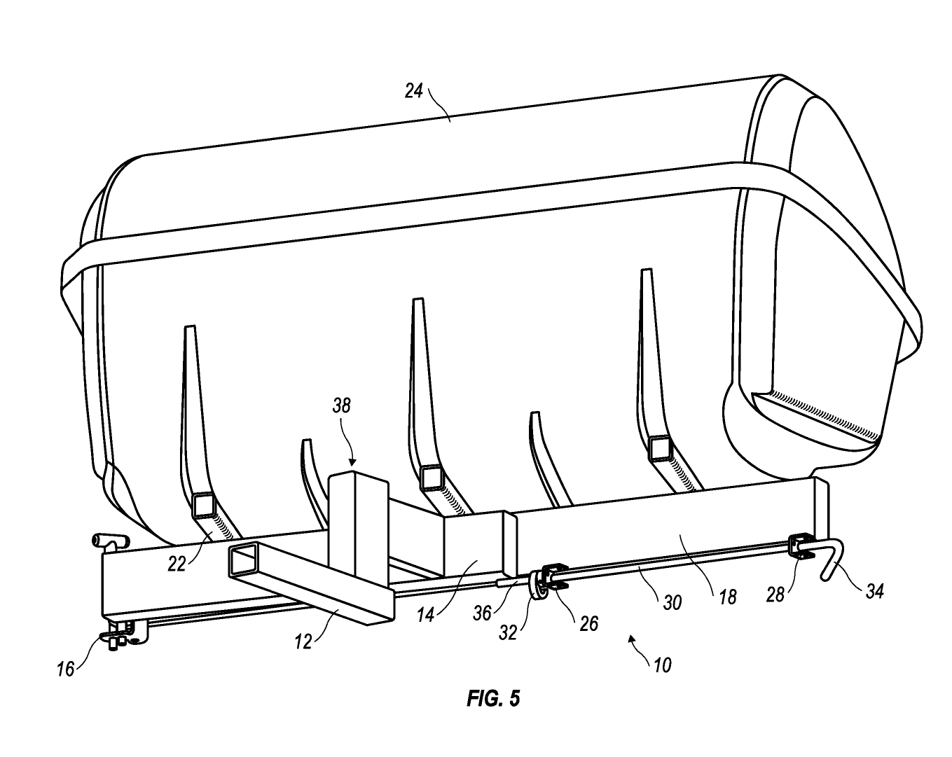

FIG. 4 and FIG. 6 are perspective views showing a partially open load carrier 10 and the use of the rotary latch 32 to engage the latch pin 36 so that the extending arm 18 will be held tightly against the support arm 14 which places the extending arm 18 in a safety and/or locked position. FIG. 5 and FIG. 7 show the load carrier 10 having the extending arm 18 in the fully locked position in which the rotary latch 32 occupies its fully engaged position with the latch pin 36.

Before assuming its fully locked position, rotation of the extending arm 18 moves it in the direction of the arrow, shown in FIG. 6, until the extending arm 18 abuts the support arm 14. At this point, the force applied by the extending arm 18 causes the rotary latch 32 to abut and rotate about the latch pin 36. Rotation of the rotary latch 32 about the latch pin 36 is caused by the handle 34 of the latching mechanism (see FIG. 4) being rotated from a first position, where it points toward the article 24, to a second, intermediate position where it substantially points away from the article 24. This second intermediate position can be referred to as the safety position. In the safety position, the extending arm 18 is not fully locked with respect to the support arm, but is substantially prevented from moving with respect to the support arm due to the engagement of the rotary latch 32 and the latch pin 36. Where necessary, the third fully locked position can be obtained by further manually rotating the handle 34 in a downward direction that is away from the article 24.

Due to the length of the extending arm 18 and the weight of the article 24, there will be a downward force acting against the hinge 16 causing displacement or sagging of the extending arm 18. The illustration in FIG. 4 and FIG. 6 suggests sagging of the extending arm 18 that causes non-parallel alignment of the extending arm 18 relative to the support arm 14. This may unbalance the article 24 during transit. Lack of balance of the article 24 and misalignment of arms 14, 18 may be reduced significantly or eliminated using a curved latch 32 that is shaped according to the present invention.

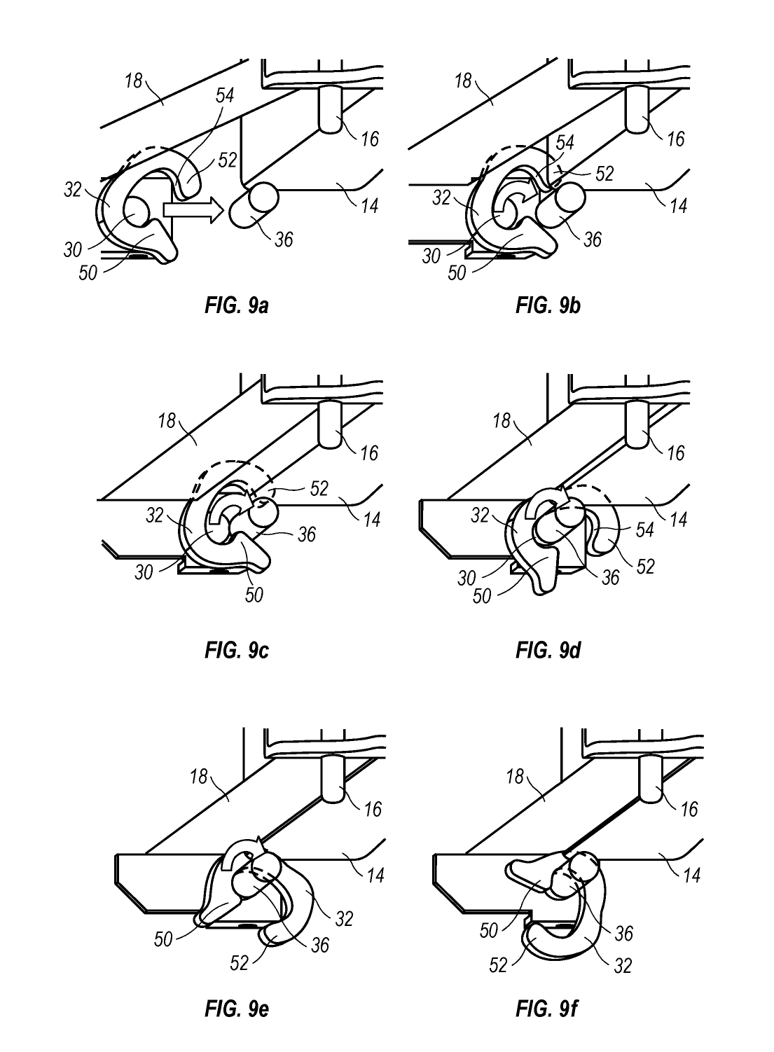

The design of the curved rotary latch 32 allows engagement with the latch pin 36 even when there is misalignment of the longitudinal axes of the extending arm 18 and the support arm 14. As indicated above, for full locking engagement between these parts 32, 36 to occur, it can be necessary to manually move the handle 34 downwards, away from the article 24 with rotation as indicated by the arrow in FIG. 7. Manual movement of the handle 34 causes the rod 30 to rotate, whereby the rotary latch 32 further engages the latch pin 36, to draw the extending arm 18 more tightly against the support arm 14. The curved latch 32 has a contact surface 54 (see FIG. 9a) that has a cam shaped contour.

As the curved latch 32 rides over the latch pin 36, the cam shaped contour has a design that repositions the extending arm 18, raising it to realign substantially parallel with the support arm 14. Following realignment, the curved latch 32 reaches its fully engaged position with the handle 34 pointing away from the article 24 (see FIG. 5), to place the extending arm 18 in its locked position for operation of the transporting vehicle. Detail of this latching mechanism will be described with reference to FIGS. 9a-9f.

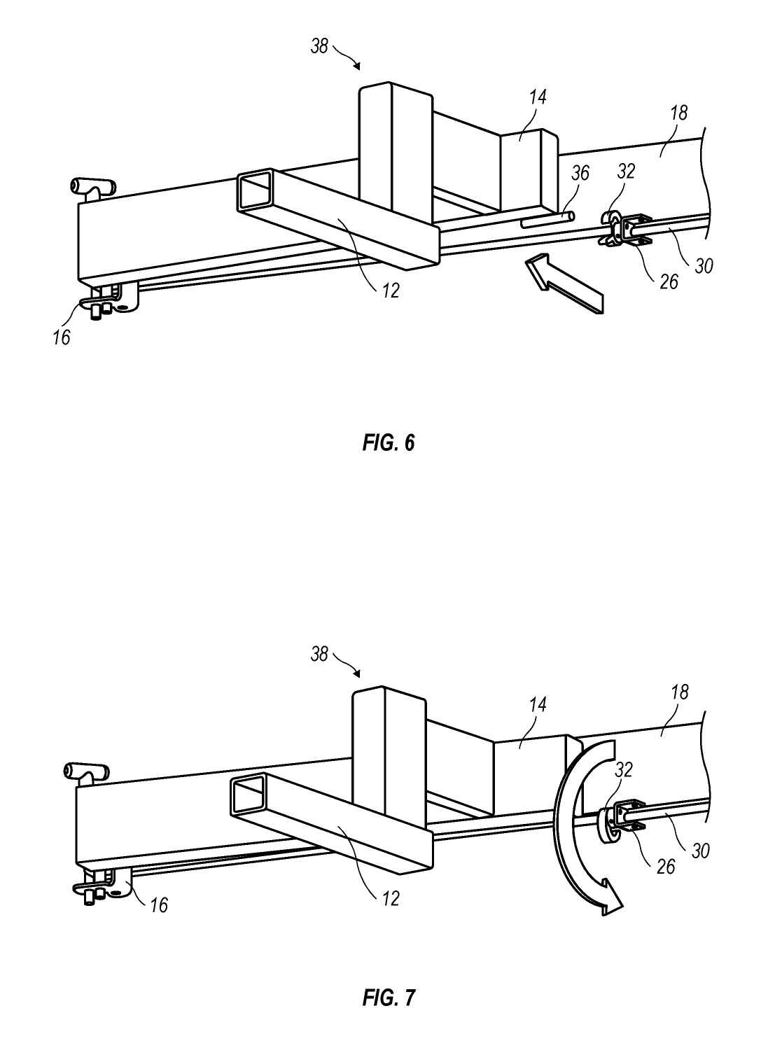

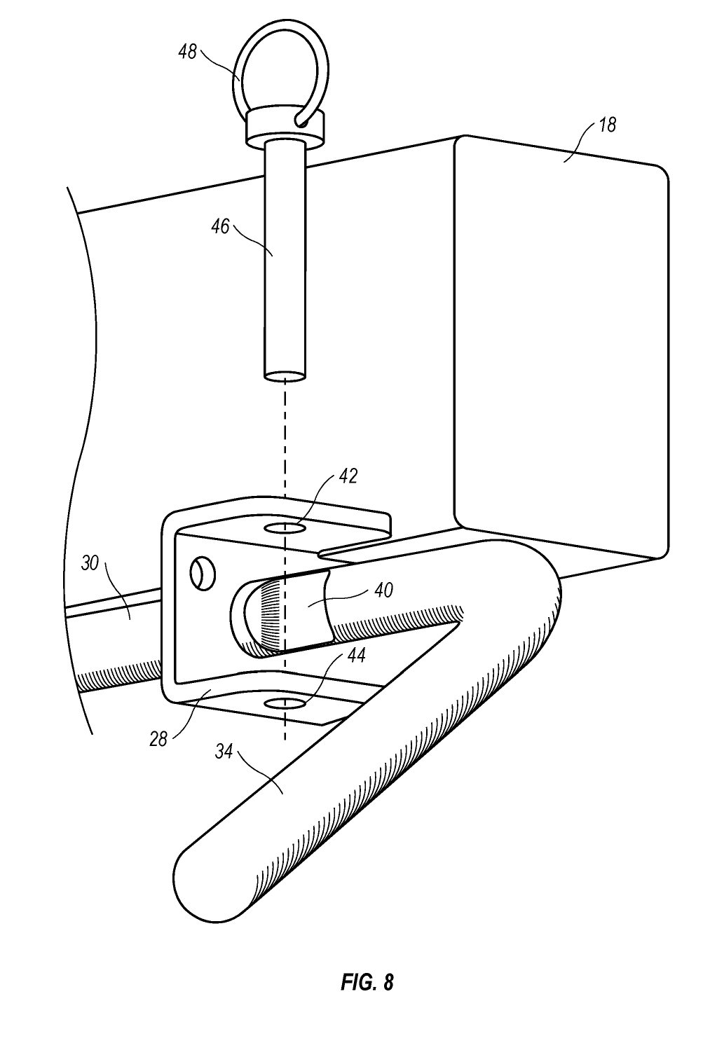

FIG. 8 shows detail of the handle 34 of a locking mechanism according to the present invention wherein the handle 34 points downwards indicating that the extending arm 18 occupies its fully locked position and the rotary latch 32 has assumed its fully engaged position. During transit of an article, the influence of gravity helps to maintain the handle 34 in the downward pointing, latch closed position. To avoid the possibility of loosening of the latching mechanism by the effect of jarring road surface bumps, an additional feature, in the form of a channel 40, insures retention of the rod 30 and rotary latch 32 to secure the extending arm 18 against the support arm (not shown) in the locked position. In this position, the channel 40 is in axial alignment with an upper hole 42 and a lower hole 44 formed in the mounting 28 for the handle portion 34 of the rotatable rod 30. Insertion of a lock pin 46 into the upper hole 42, through the channel 40, and into the lower hole 44, immobilizes the handle. A ring 48, or other suitable component attached to the lock pin 46 facilitates removal of the lock pin 46, from the mount 28, to release the handle 34 to allow release of the extending arm 18 from the support arm 14. It will be appreciated that the structure of the handle lock need not be limited to that shown in FIG. 8.

FIGS. 9a-9f show the transition of the rotary curved latch 32 from the released position of FIG. 9a, where there is separation of the extending arm 18 from the support arm 14, to the fully engaged and tightened position of FIG. 9f. The curved latch 32 has a shoulder portion 50 joined or integrally formed with the end of the rod 30. Opposite the shoulder 50, the curved latch 32 has a hooked tip 52 that passes over the latch pin 36 during initial engagement with the curved latch 32. Between the shoulder 50 and the hooked tip 52 the curved latch 32 includes a cam shaped contact surface 54 that provides a dual function of engaging the latch pin 36 and at the same time realigning the extending arm 18 and the support arm 14 so that their longitudinal axes are substantially parallel. For correlation, the partially open load carrier depicted in FIG. 9a is similar to that of FIGS. 4 and 6.

Latching of the extending arm 18 begins when it is moved towards the support arm 14, as indicated by the arrow in FIG. 9a. As the distance between the extending arm 18 and the support arm 14 decreases, the latch pin 36 passes under the hooked tip 52 towards the contact surface 54. As the cam shaped contact surface 54 rides against the surface of the latch pin 36, the curved latch 32 is rotated about the latch pin, which causes rotation of the rod 30 and handle 34 away from the article 24. At this position, the extending arm has assumed the safety position.

In a preferred embodiment, the safety position or configuration is established by the fact that the curved latch 32 latches to the latch pin 36 upon engagement thereover. That is, the weight of the handle 34 biases the curved latch 32 to the position of FIG. 9a. In this position, the curved latch 32 grasps the latch pin 36. Preferably, the natural state of the latching mechanism is the configuration of FIG. 9a under the influence of the weight of the handle 34. In this way, there is a bias on the latch 32 tending to push the rounded nose of the hooked tip 52 down, even when it rides up and over the pin 36 upon original approach to the pin 36 as depicted in FIG. 9b-9c. This is considered a safety position or configuration because it naturally causes a latching function between the curved latch 32 and the latch pin 36. Even if the latch becomes loosened from the tightened configuration described hereinbelow with respect to FIG. 9f, the latch 32 still prevents the arms 14, 18 of the carrier from swinging apart from one another because the hooked nose 52 of the latch 32 hangs on the pin 36. This can be a particularly important during times of transport when the swinging open of the arms 14, 18 would be most detrimental. Furthermore, this is also the most likely time for the tightened latch to loosen due to vibrations resulting from vehicle travel, especially if off-road or on rough roads.

To assume the locked position, a downward manual force can be applied to the handle 34 to cause further rotation of the curved latch 32 about latch pin 36 to lock the extending arm 18 with respect to the support arm 14. (see e.g. FIG. 4 and FIG. 5). FIGS. 9b and 9c show initial engagement between the curved latch 32 and the latch pin 36. With continued rotation of the curved latch 32, as indicated by the arrows of FIGS. 9d and 9e, the cam shaped contact surface 54 exerts pressure against the lock pin 36 adjusting the height of the extending arm 18 for parallel alignment with the support arm 14. Achievement of height adjustment coincides with the latch pin 36 resting next to the shoulder 50 of the curved latch 32. FIG. 9e shows the intended position.

Further rotation of the curved latch 32, e.g., as by applying a manual downwardly directed force upon the handle 18, fully engages the latch pin 36 (FIG. 9f) so that the curved latch 32 adopts its fully engaged position, securing and locking the extending arm 18 against the support arm 14. It will be appreciated that a variety of latching mechanisms may be equally useful for manually or automatically securing an extending arm 18 to a support arm 14 providing the mechanism achieves a dual purpose for latching and aligning of the arms 14, 18. Among others, the dual purpose latching mechanism is a distinguishing feature of the present invention compared to, for example, the lock pin of U.S. Pat. No. 6,237,823 which uses a spring-loaded lock pin that automatically seats in an aperture for the single purpose of securing a swing away arm in a travel position. Similarly the dog-legged pin of U.S. Pat. No. 5,439,151 connects two tabs, welded on a rear jaw member, to a front jaw member only for securing the two jaw members when the swing-away frame is in its closed position.

A swing away load carrier and its components have been described herein. These and other variations which will be appreciated by those skilled in the art are within the intended scope of this invention as claimed below.

What is claimed is:

1. A vehicular load carrier comprising:
a hinge having an open position and a closed position;
a first beam having a first end attached to said hinge, said first beam having a second end including a projection;
a second beam attached to said hinge for rotation relative to said first beam, said second beam including an edge; and
a rod mounted to rotate at said edge, said rod having a handle opposite a curved latch, said handle rotating between a first position and a second position to move said curved latch from a released position to an engaged position with said projection when said hinge is in said closed position.

2. The vehicular load carrier of claim 1, further including a stinger for insertion in a hitch mount receiver of the vehicle.

3. The vehicular load carrier of claim 2, further including a connector joining said stinger to said second end of said first beam.

4. The vehicular load carrier of claim 1, wherein said projection is a cylindrical post extending outwardly from said second end.

5. The vehicular load carrier of claim 1, having a first beam length and a second beam length, said second beam length being greater than said first beam length.

6. The vehicular load carrier of claim 5, wherein said first beam length is half said second beam length.

7. The vehicular load carrier of claim 5, further including a frame secured to said second beam.

8. The vehicular load carrier of claim 7, further including a storage container attached to said frame.

9. The vehicular load carrier of claim 1, wherein said rod is an elongate rod having a longitudinal axis and a proximate end opposite a distal end, said curved latch integrally formed at said proximate end, said handle at said distal end extending perpendicular to said longitudinal axis.

10. The vehicular load carrier of claim 9, wherein said rod is suspended from said edge between a pair of mounts that permit said rod to rotate at least between said first position and said second position.

11. The vehicular load carrier of claim 1, wherein said curved latch has a cam shaped contact surface for positional adjustment when securing said first beam to said second beam.

12. The vehicular load carrier of claim 1, wherein said second beam rotates horizontally about said hinge relative to said first beam.

13. The vehicular load carrier of claim 1, further including a locking mechanism adjacent to said distal end of said rod to retain said handle in said second position when said curved latch is in said engaged position with said projection.

14. The vehicular load carrier of claim 13, wherein said locking mechanism includes an opening to receive an elongate locking device.

15. The vehicular load carrier of claim 14, wherein said elongate locking device is selected from the group consisting of a lock pin, a spring pin, and a barrel lock and the like.

16. The vehicular load carrier of claim 1, said first beam further having a top surface and a bottom surface, said projection secured to said bottom surface.

17. The vehicular load carrier of claim 1, wherein said edge is a downward facing edge.

18. A vehicular load carrier comprising:
a hinge having an open position and a closed position;
a first beam having a first end attached to said hinge, said first beam having a second end including a projection;
a second beam attached to said hinge for rotation relative to said first beam, said second beam including an edge; and
a rod mounted to rotate at said edge, said rod having a handle opposite a curved latch, which engages and rotates about a projection when said hinge is moved to said closed position.

19. The vehicular load carrier of claim 18, wherein said curved latch engages said latch pin in a first position, and said handle is operated to further engage said curved latch.

20. The vehicular load carrier of claim 18, further including a stinger for insertion in a hitch mount receiver of the vehicle.

21. The vehicular load carrier of claim 18, having a first beam length and a second beam length, said second beam length being greater than said first beam length.

22. The vehicular load carrier of claim 21, further including a frame secured to said second beam.

23. The vehicular load carrier of claim 18, wherein said rod is an elongate rod having a longitudinal axis and a proximate end opposite a distal end, said curved latch integrally formed at said proximate end, said handle at said distal end extending perpendicular to said longitudinal axis.

24. The vehicular load carrier of claim 18, wherein said curved latch has a cam shaped contact surface for positional adjustment when securing said first beam to said second beam.

25. The vehicular load carrier of claim 18, further including a locking mechanism adjacent to said distal end of said rod to retain said handle in said second position when said curved latch is in said engaged position with said projection.

26. The vehicular load carrier of claim 25, wherein said locking mechanism includes an opening to receive an elongate locking device.

27. A vehicle mountable load carrier comprising:
a stinger for insertion in a hitch mount receiver of the vehicle;
a hinge having an open position and a closed position;
a first beam having a first end attached to said hinge, said first beam having a second end including a projection;
a connector joining said stinger to said second end of said first beam;
a second beam attached to said hinge for rotation relative to said first beam, said second beam including an edge; and
a rod mounted to rotate at said edge, said rod having a handle opposite a curved latch, said handle rotating between a first position and a second position to move said curved latch from a released position to an engaged position with said projection when said hinge is in said closed position said curved latch including a cam shaped surface for positional adjustment of said first beam during movement between said released position and said engaged position.

28. A method for securing an extending arm of a vehicular load carrier, comprising the steps of:
providing the vehicular load carrier received in the hitch of a vehicle, said vehicular load carrier comprising a hinge having an open position and a closed position; a first beam having a first end attached to said hinge, said first beam having a second end including a projection; a second beam attached to said hinge to provide said extending arm for rotation relative to said first beam, said second beam including an edge; and a rod mounted to rotate at said edge, said rod having a handle opposite a curved latch, said handle rotating between a first position and a second position to move said curved latch from a released position to an engaged position with said projection when said hinge is in said closed position; and
placing said hinge in said closed position;
rotating said handle from said first position to said second position to place said curved latch in said engaged position to secure said extending arm against said first beam in a locked position.
